(19) United States
(12) Patent Application Publication
(10) Pub. No.: US 2019/0135482 A1
(43) Pub. Date: May 9, 2019

(54) DISPLAY CONTAINER

(71) Applicant: KapStone Container Corporation, Northbrook, IL (US)

(72) Inventors: Jeffrey P. PRATSCH, Crystal, MN (US); Michael B. MCLEOD, Romeoville, IL (US)

(21) Appl. No.: 16/139,560

(22) Filed: Sep. 24, 2018

Related U.S. Application Data
(60) Provisional application No. 62/561,926, filed on Sep. 22, 2017.

(51) Int. Cl. B65D 5/54; B65D 5/02; B65D 5/468; B31B 50/20; B31B 50/26; B31B 50/62

(52) U.S. Cl. CPC B65D 5/542; B65D 5/0227; B65D 5/4608; B31B 2110/35; B31B 50/26; B31B 50/624; B31B 50/20

(57) ABSTRACT

A container in accordance with the present disclosure includes a display tray and a removable lid. The removable lid is separated from the tray at the selection of a user to expose product stored in the container for display in the tray.

### PRIORITY CLAIM

This application claims priority under 35 U.S.C. § 119(e) to U.S. Provisional Application Ser. No. 62/561,926, filed Sep. 22, 2017, which is expressly incorporated by reference herein.

### BACKGROUND

The present disclosure relates to a container, and particularly to a display container. More particularly, the present disclosure relates to a display container used to transport product stored in the display container.

### SUMMARY

A container in accordance with the present disclosure includes a tray and a removable lid coupled to the display tray. The removable lid is separated from the tray to expose products retained in the tray for display in a retail setting.

In illustrative embodiments, the container is formed using a single blank of material. The blank is folded such that portions of the blank are coupled together to retain the shape of the container and couple the lid to the tray for storage of the products during shipping. Perforations are formed in the blank to allow a user to tear the removable lid away from the tray without damaging the tray.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a front perspective view of a display container in accordance with the present disclosure showing that the display container includes a lid and a tray and suggesting that opener strips allow the lid to be separated from the tray as shown in FIGS. 2-4;

FIG. 2 is a view similar to FIG. 1 showing the opener strips peeled away along perforated tear lines as part of a process for separating the lid from the tray to expose product stored in the display container for display using the tray as suggested in FIG. 4;

FIG. 3 is a view similar to FIG. 2 showing the lid rotated relative to the tray and suggesting that the lid can be separated from the tray along perforated tear lines as shown in FIG. 4;

FIG. 4 is a view similar to FIG. 3 showing the lid removed from the tray so that product held in the tray can be displayed in a retail setting;

FIG. 5 is top plan view of a blank used to form the container of FIG. 1 showing that the blank includes a series of panels and suggesting that adhesive layers are applied to the blank for coupling portions of the blank together while allowing other portions of the blank to be in confronting relation without being adhered for erecting of the display container as suggested in FIGS. 6-19;

FIGS. 6-12 are a series of views showing a process for folding the blank of FIG. 5 to establish an un-erected container;

FIGS. 13-19 are a series of views showing a process for erecting the display container of FIG. 1, filling the container with product, and closing the container for storage or shipment;

FIG. 20 is a top plan view of a blank used to form another embodiment of the container having an additional panel that includes a diagonal tear strip;

FIG. 21 is a top plan view of a blank used to form the yet another embodiment of the container having an additional panel that does not include a diagonal tear strip;

FIG. 22 is a top plan view of a blank used to form even yet another embodiment of the container having an additional partial-length panel;

FIG. 23 is a perspective view of still another embodiment of a container; and

FIG. 24 is a top plan view of a blank used to form the container of FIG. 23.

### DETAILED DESCRIPTION

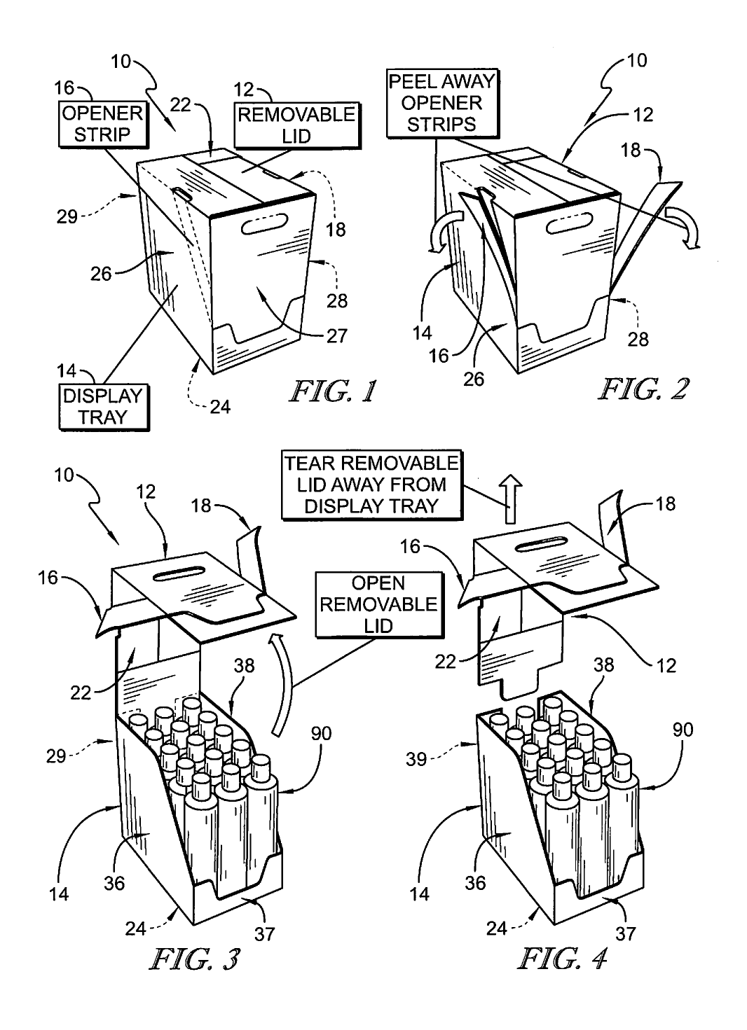

A display container 10 in accordance with the present disclosure is shown in FIG. 1. Display container 10 is formed to include perforations to allow separation of portions of display container 10 along tear lines defined by the perforations as suggested in FIGS. 2-4. A user grips a portion of display container 10 to tear the material forming display container 10 along the tear lines to cause a lid 12 to be formed and removed from a tray 14 so that product 90 stored in display container 10 is retained and displayed in tray 14.

In the illustrative embodiment, display container 10 includes a removable lid 12 coupled to a display tray 14 in a closed configuration to define a top wall 22, bottom wall 24, left-side wall 26, right-side wall 28, front wall 27, and back wall 29 as shown in FIG. 1. Opener strips 16, 18 are defined by perforation lines extending along left-side and right-side walls 26, 28 extending from top wall 22 toward front wall 27. A user grips an upper end of opener strips 16, 18 and pulls outward to break the perforation lines as suggested in FIG. 2. A user rotates removable lid 12 relative to tray 14 to break perforation lines extending along corner edges between left-side wall 26 and top wall 22 and right-side wall 28 and top wall 22 to expose product 90 stored in display container 10 as suggested in FIG. 3. A user separates removable lid 12 from tray 14 along perforation lines extending through back wall 29 for display of product 90 in tray 14.

A portion of front wall 27 is removed with lid 12 leaving a retainer wall 37 on tray 14. Portions of left-side and right-side walls 26, 28 are removed with lid 12 leaving support walls 36, 38 on tray 14. In the illustrative embodiment, a portion of back wall 29 is removed with lid 12 leaving a rear wall 39 on tray 14. Top wall 22 is removed with lid 12 and bottom wall 24 remains with tray 14.

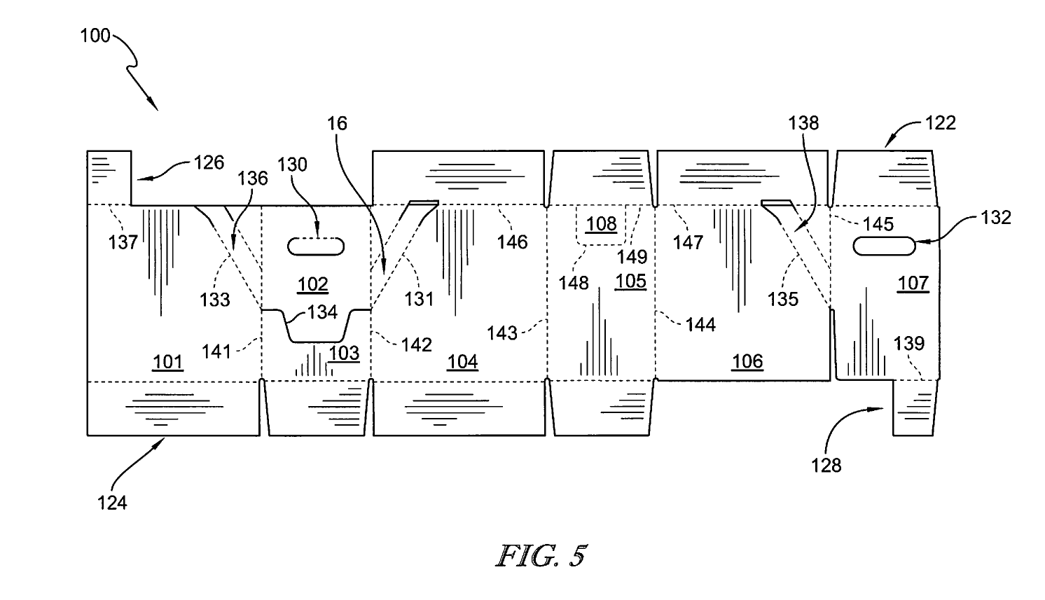

An embodiment of a one-piece blank 100 used to form display container 10 is shown in FIG. 5. As shown and described herein, when making reference to a blank of material, solid lines denote a cut line where adjacent portions of material are severed from one another and dashed lines denote a fold line where portions of material are folded relative to one another. In some examples, fold lines are scored or perforated. It is within the scope of the present disclosure to make blanks from a variety of materials including corrugated paperboard, folding carton, solid fiber, plastic sheeting, plastic corrugated, combinations thereof, or any other suitable material.

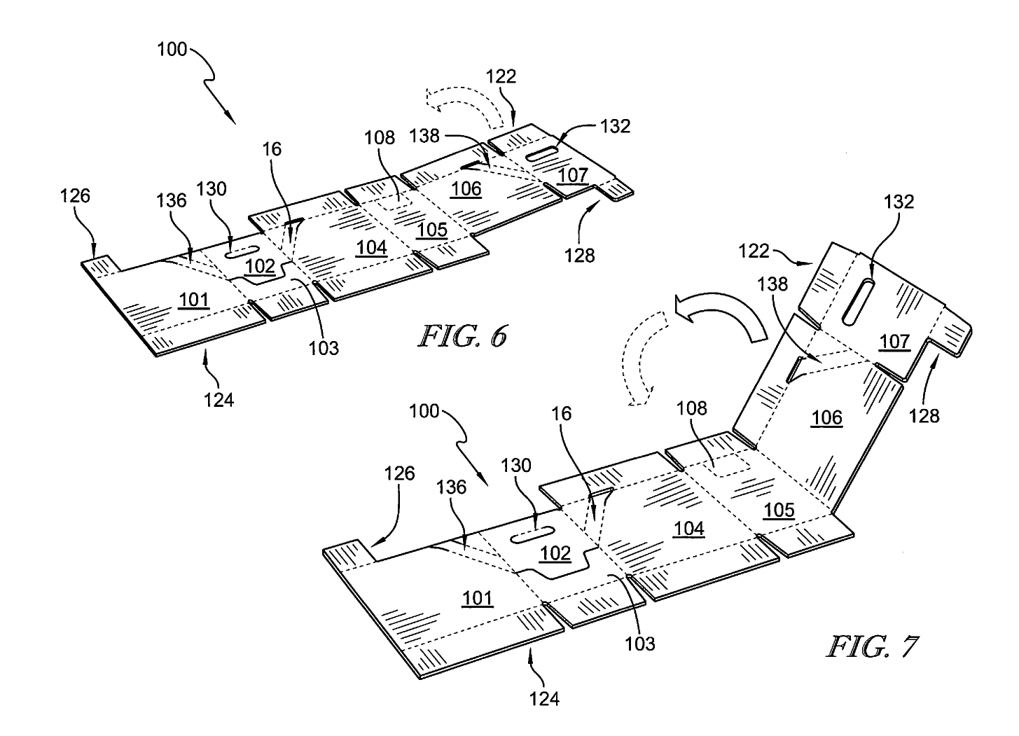

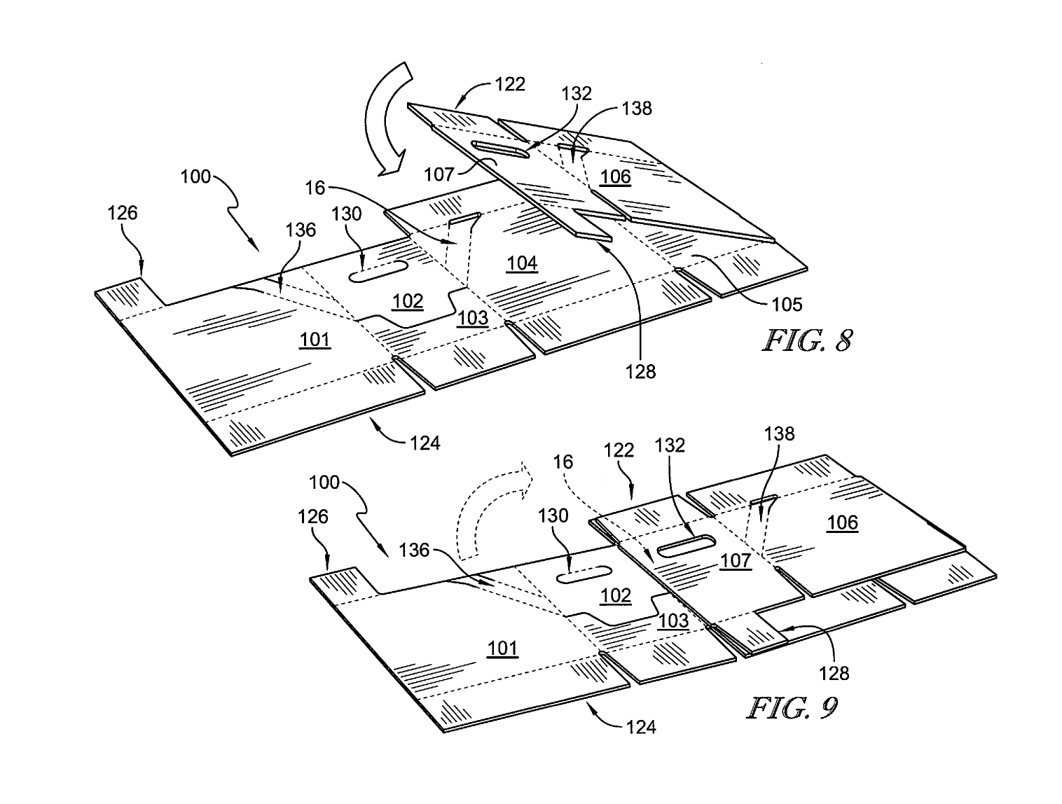

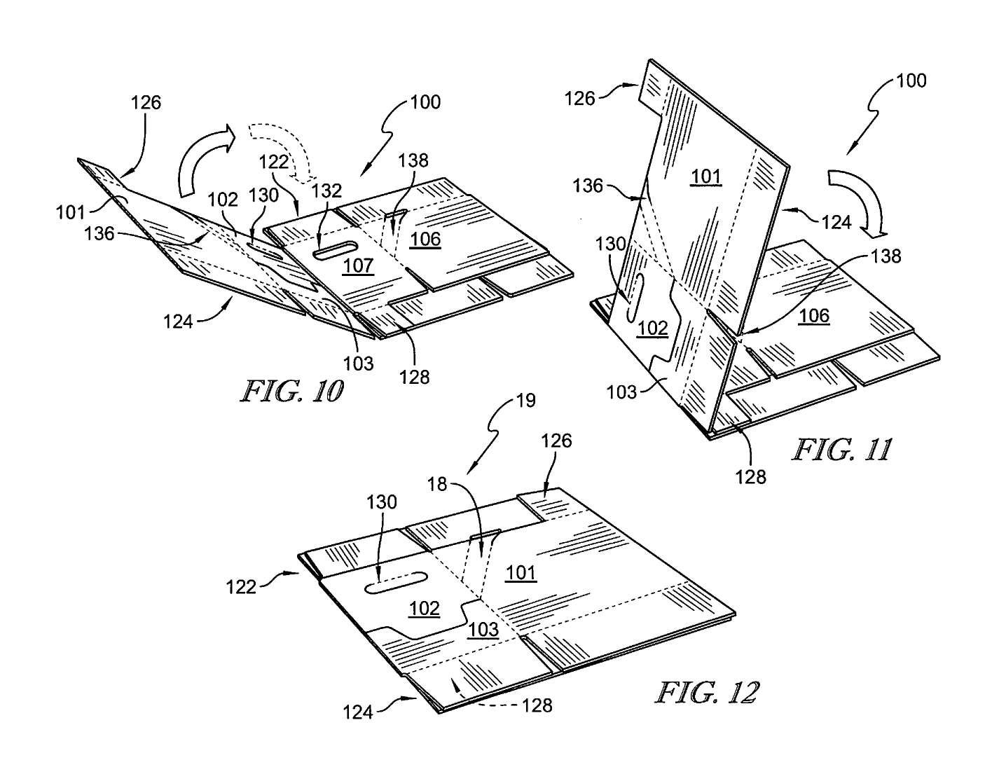

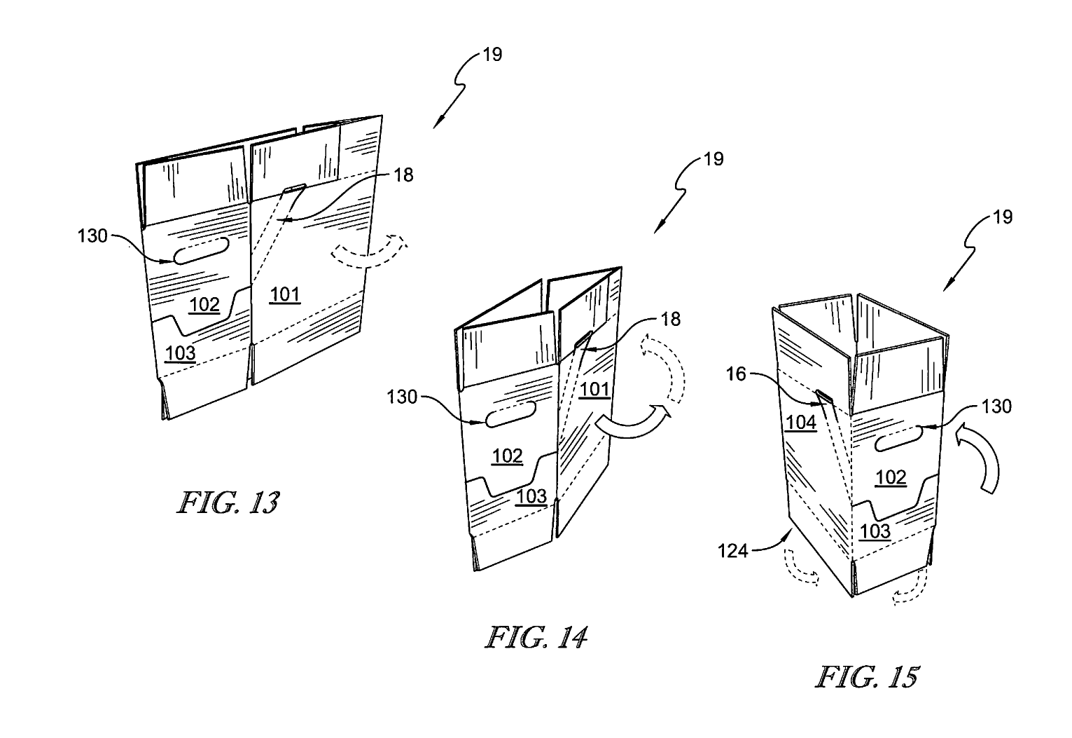

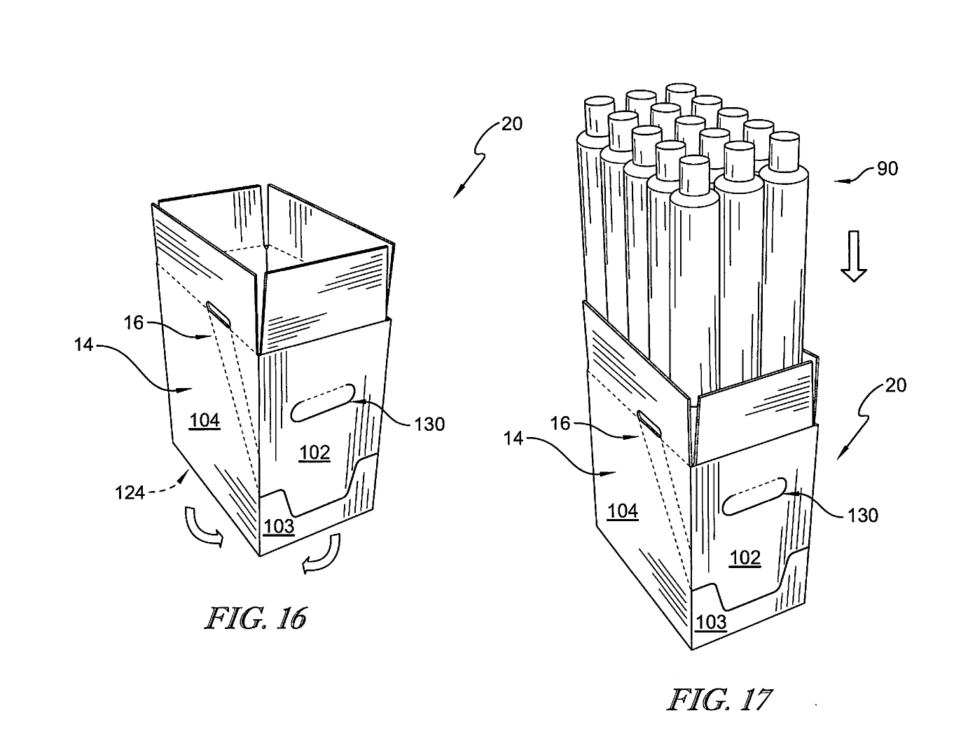

One-piece blank 100 includes a plurality of integrally connected panels 101-107 and closure flaps 122, 124 as shown in FIG. 5. A user folds panels 101-107 relative to one another to form an un-erected container 19 as shown in FIGS. 6-12. Adhesive layers included on one-piece blank 100 couple portions of blank 100 together to retain the shape of un-erected container 19. A user expands un-erected container 19 and folds flaps 124 to form an open container as suggested in FIGS. 13-16. Product 90 is placed into open container 20 and flaps 122 are folded to form display container 10 as suggested in FIGS. 17-19.

Panel 101 of one-piece blank 100 is coupled to panels 102, 103 along a fold line 141 as shown in FIG. 5. Panel 104 is coupled to an opposite side of panels 102, 103 from panel 101 along a fold line 142. A cut line 134 extends from fold line 141 to fold line 142 to separate panel 102 from panel 103. Panel 105 is coupled to an opposite side of panel 104 from panels 102, 103 along a fold line 143. Panel 106 is coupled to an opposite side of panel 105 from panel 104 along a fold line 144. Panel 107 is coupled to an opposite side of panel 106 from panel 105 along a fold line 145. Upper closure flaps 122 are coupled to upper edges of panels 104, 105, 106, 107 and lower closure flaps 124 are coupled to lower edges of panels 101, 103, 104, 105.

In the illustrative embodiment, opener strip 16 is formed into panel 104 along separation lines 131 as shown in FIG. 5. Opener-strip parts 136, 138 are formed into panels 101, 106, respectively, and combine to form opener strip 18. Opener-strip part 136 is formed along separation lines 133 and opener-strip part 138 is formed along separation lines 135. In some embodiments, an upper portion of opener strips 16, 18 are pre-cut into display container 10 for ease of user in peeling opener strips 16, 18 during removal of lid 12 from tray 14. A separation line 146 extends along an upper edge of panel 104 beginning at opener strip 16 and extending toward fold line 143. A separation line 147 extends along an upper edge of panel 106 beginning at opener-strip part 138 and extending toward fold line 144. Separation lines 146, 147 allow separation of closure flaps 122 from panels 104, 106, respectively, during removal of lid 12 from tray 14. A grip flap 130 is coupled to panel 102 and a window 132 is formed through panel 107. Grip flap 130 closes window 132 when display container 10 is erected and allows a user to grip lid 12 for removal from tray 14 as detailed herein.

In the illustrative embodiment, a break-away tab 108 is formed into panel 105 and separates from tray 14 with removal of lid 12. A separation line 148 allows break-away tab 108 to separate from panel 105. Separation lines 149 extend outward from break-away tab 108 and allow separation of one of the closure flaps 122 from panel 105 during removal of lid 12 from tray 14. In some embodiments, a reinforcement tab 126 is coupled to an upper edge of panel 101 and a reinforcement tab 128 is coupled to a lower edge of panel 107. In some embodiments, separation lines 137, 139 allow separation of reinforcement tabs 126, 128 from panels 101, 107, respectively.

One illustrative process for forming an un-erected container 19 is shown in FIGS. 6-12. Panel 106 is folded relative to panel 105 along fold line 144 to position panels 106, 107 along panels 104, 105 as shown in FIGS. 6-9. Panels 102, 103 are folded relative to panel 104 along fold line 142 to position panels 101, 102, 103 along panels 106, 107 as shown in FIGS. 9-12. Grip flap 130 aligns with window 132 and opener-strip part 136 aligns with opener-trip part 138. A first adhesive layer bonds panel 101 with panel 106 to retain the shape of tray 14 after separating lid 12 from tray 14. A second adhesive layer bonds panel 102 with panel 107.

Panels 102, 107, closure flaps 122, and opener strips 16, 18 together form lid 12. Panels 101, 103, 104, 105, 106 and closure flaps 124 together form tray 14. In the illustrative embodiment, perforations are formed following the dashed lines extending along opener strips 16, 18 and the top of panels 104-106. In some embodiments, perforations are formed between panel 101 and reinforcement tab 126, between panel 107 and reinforcement tab 128, and/or between panel 105 and break-away tab 108.

As suggested in FIGS. 6-12, portions of blank 100 are folded relative to one another such that the adhesive layers bond panel 101 with panel 106, and panel 102 with panel 107, to establish un-erected container 19. A lower portion of panel 107 is positioned inside of panel 103 and in confronting relation with panel 103 without being bonded together. Upper closure flaps 122 together define top wall 22 of display container 10 when closed. Lower closure flaps 124 together define bottom wall 24 of display container 10 when closed. Panel 104 defines left-side wall 26 of display container 10. Panels 101, 106 together define right-side wall 28 of display container 10. Panels 102, 103, 107 together define front wall 27 of display container 10. Panel 105 defines back wall 29 of display container 10.

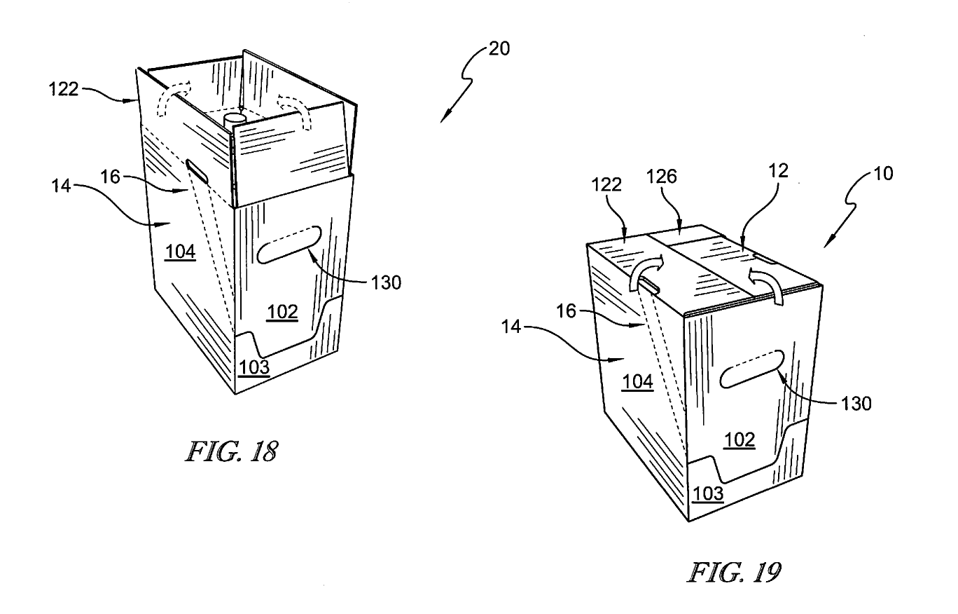

As suggested in FIGS. 13-16, un-erected container 19 is expanded and lower closure flaps 124 of tray 14 are folded relative to one another to define bottom wall 24 of display container 10 and establish an open container 20. A user places product 90 into open container 20 through an upper opening as suggested in FIGS. 17 and 18. Upper closure flaps 122 of lid 12 are folded relative to one another to define top wall 22 of display container 10 and enclose product 90 within display container 10 for storage or transport as suggested in FIGS. 18-19.

Display containers in accordance with the present disclosure minimize waste and maximize efficiency as a result of being formed from a one-piece contiguous blank. Efficiency is further maximized as a result of the un-erected container and display container being formed without the use of specialty or custom equipment.

It is within the scope of the present disclosure to make blanks in accordance from a variety of materials including corrugated paperboard, folding carton, solid fiber, plastic sheeting, plastic corrugated, combinations thereof, or any other suitable material.

In illustrative embodiments, a retail ready package (RRP) or shelf ready package (SRP) 10 is formed in a single piece 100. A front face 27 of the package 10 is formed without any tear lines for a clean appearance.

In illustrative embodiments, a die cut blank 100 is folded and glued into a knock down flat (KDF) blank 19 that resembles a standard box or shipping container. The blank 100 contains six panels total, four panels that form the tray and two panels that overlap onto the tray panels which provide portions of the cover or lid 12. Flaps 122, 124 are included for closing the top and bottom 22, 24 of the container 10. The top flaps 122 are removed with the rest of the lid 12 while the bottom flaps 124 remain with the tray 14 to form the bottom 24 of the tray 14. After opening portions of the sides 26, 28, the upper portion of the front panel 27 can be pulled upward and towards the back 29 to remove the lid 12 and leave behind a display tray 14 that can be placed onto the store shelf.

In illustrative embodiments, a one piece design reduces packaging material inventory, works on existing equipment both manufacturing and erecting/fulfilling/sealing, provides a clean front on the display tray, allows the ability to accommodate multiple types of top and bottom sealing/closure methods (tape or glue), and there is no need to use a knife or sharp opening device while retaining a majority of stacking strength.

In illustrative embodiments, a container 10 includes a tray 14 formed to include a product-storage space adapted to hold product 90 for display of the product 90 and a lid 12 mounted on the tray 14 to capture the product 90 between the lid 12 and the tray 14 for shipping to a retail location. The lid 12 and the tray 14 are formed from a contiguous, one-piece blank of material 100 having a plurality of panels 101-107 folded relative to one another with portions bonded together to couple the lid 12 to the tray 14.

In illustrative embodiments, a one-piece blank 100 used to form a container 10 includes a plurality of first panels 101, 103, 104, 105, 106 coupled to one another and adapted to define a tray 14 when folded relative to one another and a plurality of second panels 102, 107 coupled together and adapted to define a lid 12 for mounting on the tray 14 when the second panels are folded relative to one another. At least one of the first panels is coupled with one of the second panels along a perforated tear line to allow removal of the lid 12 from the tray 14 at the selection of a user.

In illustrative embodiments, a process for making and using a display container includes the steps of providing a contiguous, one-piece blank of material 100, forming an un-erected container 19 using the one-piece blank of material 100, forming an open container 20 using the un-erected container 19, filling the open container 20 with product 90 to form a filled-open container, forming a display container 10 using the filled-open container, and separating a lid 12 included in the display container from a tray 14 included in the display container to provide the tray 14 retaining and displaying the product 90 without the use of a knife.

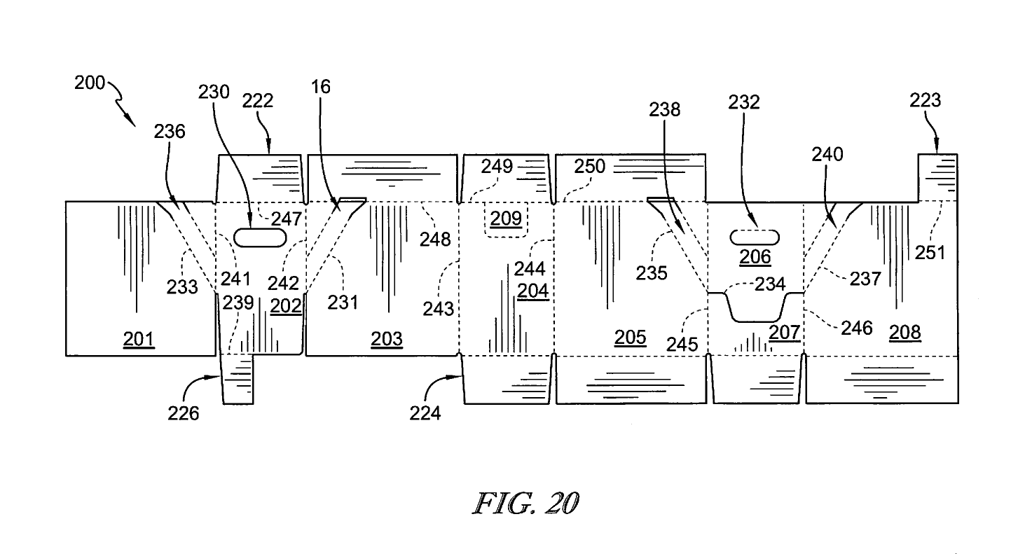

An embodiment of a one-piece blank 200 used to form another embodiment of the display container is shown in FIG. 20. Illustratively, one-piece blank 200 includes a plurality of integrally connected panels 201-208. The panel 201 is of substantially equal length to the panels 203, 205, and 208 to provide additional structural support to the display container when formed. More particularly, the addition of the panel 201 to the display container allows a side of the formed display container to have relatively equal support to an opposite side of the container.

A user folds the panels 201-208 relative to one another to form an un-erected container, similar to the un-erected container 19 as suggested in FIGS. 6-12. Adhesive layers included on one-piece blank 200 couple portions of the blank 200 together to retain the shape of the un-erected container. A user expands the un-erected container and folds flaps 224 to form an open container as suggested in FIGS. 13-16 for open container 20. Product 90 is placed in in the open container and flaps 222 are folded to form a display container as suggested in FIGS. 17-19.

Panel 201 of one-piece blank 200 is coupled to panel 202 along a fold line 241 as shown in FIG. 20. Panel 203 is coupled to an opposite side of panel 202 from panel 201 along a fold line 242. Panel 204 is coupled to an opposite side of panel 203 from panel 202 along a fold line 243. Panel 205 is coupled to an opposite side of panels 206, 207 from panel 204 along a fold line 245. A cut line 234 extends from fold line 245 to a fold line 246 to separate panel 206 from panel 207. Panels 206, 207 are coupled to panel 208 along fold line 246. Upper closure flaps 222 are coupled to upper edges of panels 202, 203, 204, and 205 and lower closure flaps 224 are coupled to lower edges of panels 204, 205, 207, and 208. In an embodiment, in assembly of the display container 10 from the blank 200, an adhesive layer bonds panel 201 with panel 208 to provide additional structural support for the formed container. Of course, in other embodiments, the panel 201 may be in contact with the panel 208 when folded and might not use an adhesive layer for bonding.

In the illustrative embodiment, opener strip 16 is formed into panel 203 along separation lines 231 as shown in FIG. 20. Opener strip 16 combines with opener-strip part 240. Opener-strip parts 236, 238 are formed into panels 201, 205, respectively, and combine to form opener strip 18. Opener-strip part 236 is formed along separation lines 233, and opener-strip part 238 is formed along separation lines 235. Opener-strip part 240 is formed along separation lines 237. As stated, an upper portion of opener strips 16, 18 are pre-cut into display container 10 for ease of user in peeling opener strips 16, 18 during removal of lid 12 from tray 14. A separation line 247 extends along an upper edge of panel 202. A separation line 248 extends along an upper edge of panel 203 beginning at opener strip 16 and extending toward fold line 243. A separation line 250 extends along an upper edge of panel 205, beginning at the opener-strip part 238 and extending toward fold line 245. Separation lines 248, 250 allow separation of closure flaps 222 from panels 203, 205, respectively, during removal of lid 12 from tray 14. A grip flap 230 is coupled to panel 202 and a window 232 is formed through panel 207. Grip flap 230 closes window 232 when display container 10 is erected and allows a user to grip lid 12 for removal from tray 14.

In the illustrative embodiment, a break-away tab 209 is formed into panel 204 and separates from tray 14 with removal of lid 12. A separation line 249 allows break-away tab 209 to separate from panel 204. Separation line 249 extends outward from break-away tab 209 and allows separation of one of the closure flaps 222 from panel 205 during removal of lid 12 from tray 14. In some embodiments, a reinforcement tab 223 is coupled to an upper edge of panel 208 and a reinforcement tab 226 is coupled to a lower edge of panel 202. In some embodiments, separation lines 251, 239 allow separation of reinforcement tabs 223, 226 from panels 208, 202, respectively.

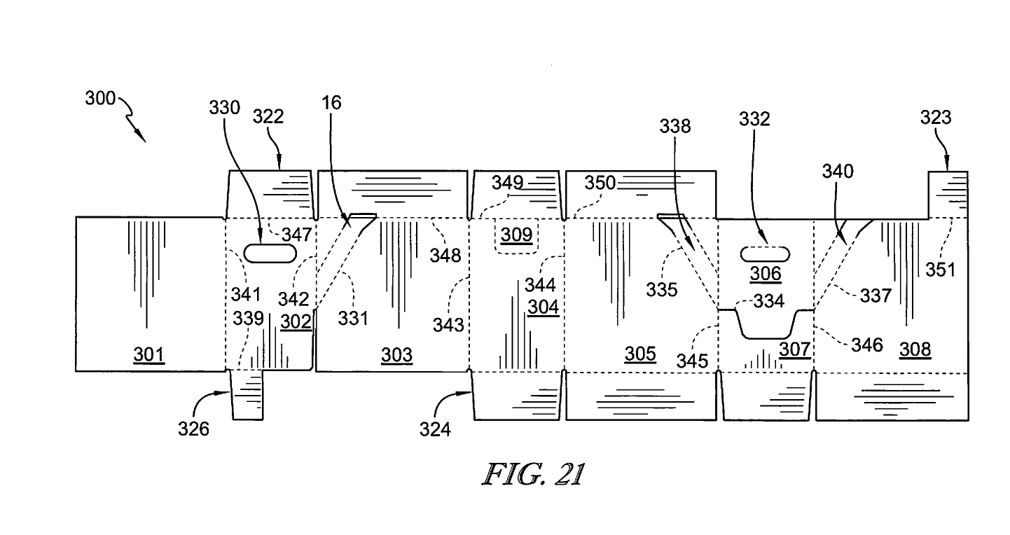

An embodiment of a one-piece blank 300 used to form another embodiment of the display container is shown in FIG. 21. Illustratively, one-piece blank 300 includes a plurality of integrally connected panels 301-308. Similar to panel 201 of blank 200 being of substantially equal length of other panels thereof, the panel 301 is of substantially equal length to the panels 303, 305, and 308 to provide additional structural support to the display container when formed. More particularly, the addition of the panel 301 to the display container allows a side of the formed display container to have relatively equal support to an opposite side of the container.

A user folds the panels 301-308 relative to one another to form an un-erected container, similar to the un-erected container 19 as suggested in FIGS. 6-12. Adhesive layers included on one-piece blank 300 couple portions of the blank 300 together to retain the shape of the un-erected container. A user expands the un-erected container and folds flaps 324 to form an open container as suggested in FIGS. 13-16 for open container 20. Product 90 is placed in in the open container and flaps 322 are folded to form a display container as suggested in FIGS. 17-19.

Panel 301 of one-piece blank 300 is coupled to panel 302 along a fold line 341 as shown in FIG. 21. Panel 303 is coupled to an opposite side of panel 302 from panel 301 along a fold line 342. Panel 304 is coupled to an opposite side of panel 303 from panel 302 along a fold line 343. Panel 305 is coupled to an opposite side of panels 306, 307 from panel 304 along a fold line 345. A cut line 334 extends from fold line 345 to a fold line 346 to separate panel 306 from panel 307. Panels 306, 307 are coupled to panel 308 along fold line 346. Upper closure flaps 322 are coupled to upper edges of panels 302, 303, 304, and 305 and lower closure flaps 324 are coupled to lower edges of panels 304, 305, 307, and 308. In an embodiment, in assembly of the display container 10 from the blank 300, an adhesive layer bonds panel 301 with panel 308 to provide additional structural support for the formed container.

In the illustrative embodiment, opener strip 16 is formed into panel 303 along separation lines 331 as shown in FIG. 21. Opener strip 16 combines with opener-strip part 340. Opener-strip part 338 is formed into panel 305 and may form opener strip 18. Opener-strip part 338 is formed along separation lines 235. Opener-strip part 340 is formed along separation lines 337. As stated, an upper portion of opener strips 16, 18 are pre-cut into display container 10 for ease of user in peeling opener strips 16, 18 during removal of lid 12 from tray 14. A separation line 347 extends along an upper edge of panel 302. A separation line 348 extends along an upper edge of panel 303 beginning at opener strip 16 and extending toward fold line 343. A separation line 350 extends along an upper edge of panel 305, beginning at the opener-strip part 338 and extending toward fold line 345. Separation lines 348, 350 allow separation of closure flaps 322 from panels 303, 305, respectively, during removal of lid 12 from tray 14. A grip flap 330 is coupled to panel 302 and a window 332 is formed through panel 307. Grip flap 330 closes window 332 when display container 10 is erected and allows a user to grip lid 12 for removal from tray 14.

In the illustrative embodiment, a break-away tab 309 is formed into panel 304 and separates from tray 14 with removal of lid 12. A separation line 349 allows break-away tab 309 to separate from panel 304. Separation line 349 extends outward from break-away tab 309 and allows separation of one of the closure flaps 322 from panel 305 during removal of lid 12 from tray 14. In some embodiments, a reinforcement tab 323 is coupled to an upper edge of panel 308 and a reinforcement tab 326 is coupled to a lower edge of panel 302. In some embodiments, separation lines 351, 339 allow separation of reinforcement tabs 323, 326 from panels 308, 302, respectively.

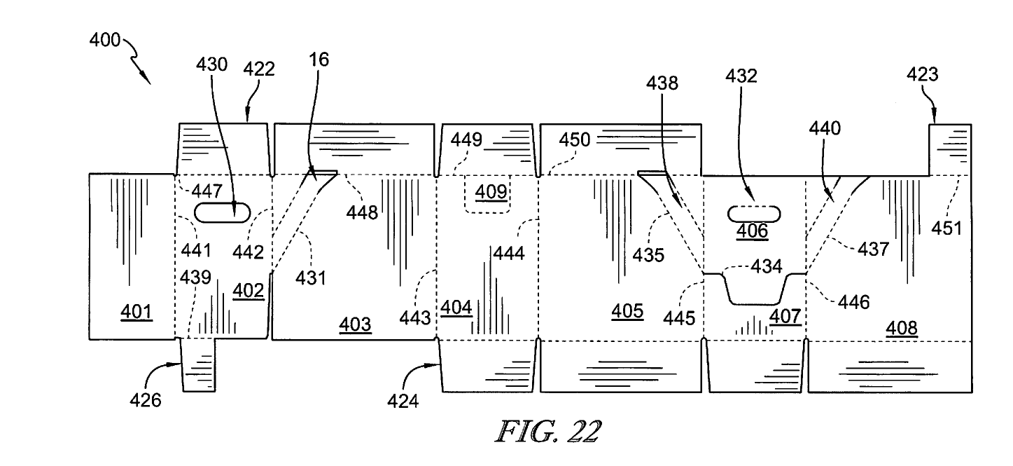

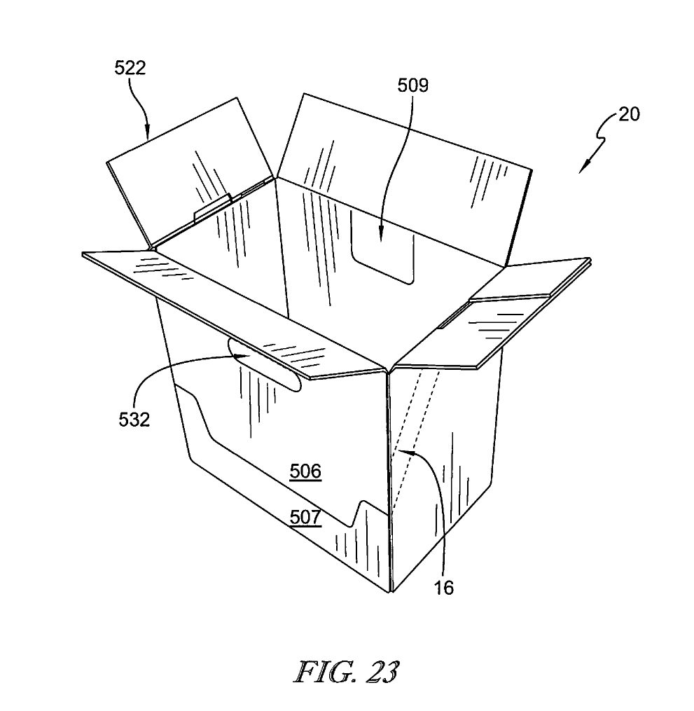

An embodiment of a one-piece blank 400 used to form still another embodiment of the display container is shown in FIG. 22. Illustratively, one-piece blank 400 includes a plurality of integrally connected panels 401-408. In contrast to the panels 201 and 301 of blanks 200 and 300, respectively, being of substantially equal length to panels thereof, the panel 401 is of partial length of the panels 403, 405, and 408 to equalize structural support in a front side of a container formed from the blank 400. Particularly, when formed, the panel 401 provides an additional corner at the front side of the container. The panel 401 may be equal or lesser size of the panels 403, 405, and 408.

A user folds the panels 401-408 relative to one another to form an un-erected container, similar to the un-erected container 19 as suggested in FIGS. 6-12. Adhesive layers included on one-piece blank 400 couple portions of the blank 400 together to retain the shape of the un-erected container. A user expands the un-erected container and folds flaps 424 to form an open container as suggested in FIGS. 13-16 for open container 20. Product 90 is placed in in the open container and flaps 422 are folded to form a display container as suggested in FIGS. 17-19.

Panel 401 of one-piece blank 400 is coupled to panel 402 along a fold line 441 as shown in FIG. 22. Panel 403 is coupled to an opposite side of panel 402 from panel 401 along a fold line 442. Panel 404 is coupled to an opposite side of panel 403 from panel 402 along a fold line 443. Panel 405 is coupled to an opposite side of panels 406, 407 from panel 404 along a fold line 445. A cut line 434 extends from fold line 445 to a fold line 446 to separate panel 406 from panel 407. Panels 406, 407 are coupled to panel 408 along fold line 446. Upper closure flaps 422 are coupled to upper edges of panels 402, 403, 404, and 405 and lower closure flaps 424 are coupled to lower edges of panels 404, 405, 407, and 408. In an embodiment, in assembly of the display container 10 from the blank 400, an adhesive layer bonds panel 401 with panel 408 to provide additional structural support for the formed container, such as by equalizing the structural strength thereof.

In the illustrative embodiment, opener strip 16 is formed into panel 403 along separation lines 431 as shown in FIG. 22. Opener strip 16 combines with opener-strip part 440. Opener-strip part 438 is formed into panel 405 and may form opener strip 18. Opener-strip part 438 is formed along separation lines 435. Opener-strip part 440 is formed along separation lines 437. As stated, an upper portion of opener strips 16, 18 are pre-cut into display container 10 for ease of user in peeling opener strips 16, 18 during removal of lid 12 from tray 14. A separation line 447 extends along an upper edge of panel 402. A separation line 448 extends along an upper edge of panel 403 beginning at opener strip 16 and extending toward fold line 443. A separation line 450 extends along an upper edge of panel 405, beginning at the opener-strip part 438 and extending toward fold line 445. Separation lines 448, 450 allow separation of closure flaps 422 from panels 403, 405, respectively, during removal of lid 12 from tray 14. A grip flap 430 is coupled to panel 402 and a window 432 is formed through panel 407. Grip flap 430 closes window 432 when display container 10 is erected and allows a user to grip lid 12 for removal from tray 14.

In the illustrative embodiment, a break-away tab 409 is formed into panel 404 and separates from tray 14 with removal of lid 12. A separation line 449 allows break-away tab 409 to separate from panel 404. Separation line 449 extends outward from break-away tab 409 and allows separation of one of the closure flaps 422 from panel 405 during removal of lid 12 from tray 14. In some embodiments, a reinforcement tab 423 is coupled to an upper edge of panel 408 and a reinforcement tab 426 is coupled to a lower edge of panel 402. In some embodiments, separation lines 451, 439 allow separation of reinforcement tabs 423, 426 from panels 408, 402, respectively.

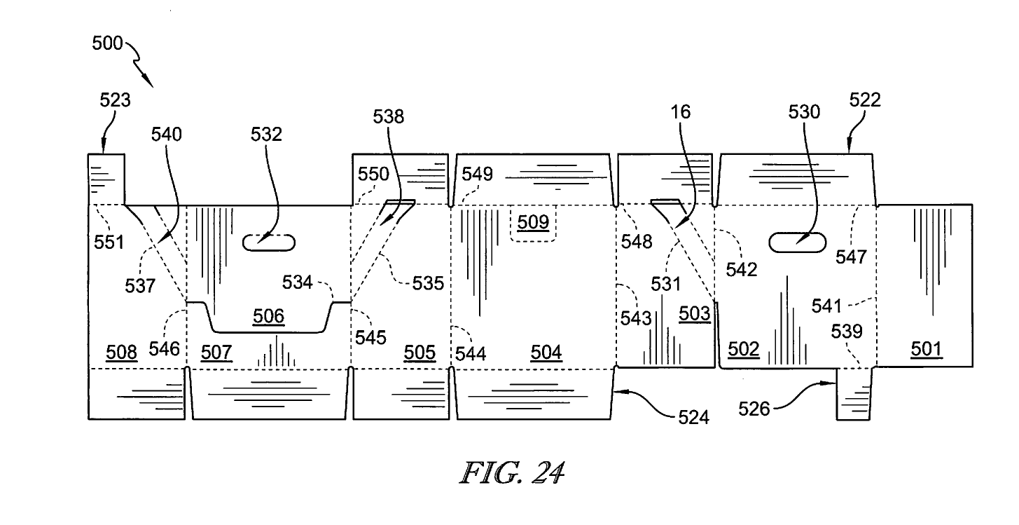

Another embodiment of the display container 10 is shown in FIG. 23. In this example, display container 10 (depicted here as open container 20) is formed of a blank 500 further described relative to FIG. 24. In particular, the blank 500 shares common characteristics with the blank 400 of FIG. 22. However, length and width dimensions in the blank 500 are reversed relative to the length and width dimensions of the blank 400. Further, window 532 is formed through a panel 506. In other words, the window 532, in contrast to the blanks 100, 200, 300, and 400, is formed on a relatively wider panel. One of skill in the art will recognize that a forming of the display container 10 can occur regardless of whether the vertical panel is wide or narrow.

Illustratively, one-piece blank 500 includes a plurality of integrally connected panels 501-508 as shown in FIG. 24. In contrast to the panels 201 and 301 of blanks 200 and 300, respectively, being of substantially equal length to panels thereof, the panel 501 is of partial length of the panels 502, 504, and 507 to equalize structural support in a front side of a container formed from the blank 400. Particularly, when formed, the panel 501 provides an additional corner at the front side of the container. The panel 501 may be equal or lesser size of the panels 502, 504, and 507.

A user folds the panels 501-508 relative to one another to form an un-erected container, similar to the un-erected container 19 as suggested in FIGS. 6-12. Adhesive layers included on one-piece blank 500 couple portions of the blank 500 together to retain the shape of the un-erected container. A user expands the un-erected container and folds flaps 524 to form an open container as suggested in FIGS. 13-16 for open container 20. Product 90 is placed in in the open container and flaps 522 are folded to form a display container as suggested in FIGS. 17-19.

Panel 501 of one-piece blank 500 is coupled to panel 502 along a fold line 541 as shown in FIG. 24. Panel 503 is coupled to an opposite side of panel 502 from panel 501 along a fold line 542. Panel 504 is coupled to an opposite side of panel 503 from panel 502 along a fold line 543. Panel 505 is coupled to an opposite side of panels 506, 507 from panel 504 along a fold line 545. A cut line 534 extends from fold line 545 to a fold line 546 to separate panel 506 from panel 507. Panels 506, 507 are coupled to panel 508 along fold line 546. Upper closure flaps 522 are coupled to upper edges of panels 502, 503, 504, and 505 and lower closure flaps 524 are coupled to lower edges of panels 504, 505, 507, and 508. In an embodiment, in assembly of the display container 10 from the blank 500, an adhesive layer bonds panel 501 with panel 508 to provide additional structural support for the formed container, such as by equalizing the structural strength thereof.

In the illustrative embodiment, opener strip 16 is formed into panel 503 along separation lines 531 as shown in FIG. 24. Opener strip 16 combines with opener-strip part 540. Opener-strip part 538 is formed into panel 505 and may form opener strip 18. Opener-strip part 538 is formed along separation lines 535. Opener-strip part 540 is formed along separation lines 537. As stated, an upper portion of opener strips 16, 18 are pre-cut into display container 10 for ease of user in peeling opener strips 16, 18 during removal of lid 12 from tray 14. A separation line 547 extends along an upper edge of panel 502. A separation line 548 extends along an upper edge of panel 503 beginning at opener strip 16 and extending toward fold line 543. A separation line 550 extends along an upper edge of panel 505, beginning at the opener-strip part 538 and extending toward fold line 545. Separation lines 548, 550 allow separation of closure flaps 522 from panels 503, 505, respectively, during removal of lid 12 from tray 14. A grip flap 530 is coupled to panel 502 and a window 532 is formed through panel 507. Grip flap 530 closes window 532 when display container 10 is erected and allows a user to grip lid 12 for removal from tray 14.

In the illustrative embodiment, a break-away tab 509 is formed into panel 504 and separates from tray 14 with removal of lid 12. A separation line 549 allows break-away tab 509 to separate from panel 504. Separation line 549 extends outward from break-away tab 509 and allows separation of one of the closure flaps 522 from panel 505 during removal of lid 12 from tray 14. In some embodiments, a reinforcement tab 523 is coupled to an upper edge of panel 508 and a reinforcement tab 526 is coupled to a lower edge of panel 502. In some embodiments, separation lines 551, 539 allow separation of reinforcement tabs 523, 526 from panels 508, 502, respectively.

1. A container comprising
a top wall,
a bottom wall spaced apart from the top wall,
a front wall extending from the bottom wall to the top wall,
a back wall spaced apart from the front wall and extending from the bottom wall to the top wall,
a left-side wall extending from the bottom wall to the top wall and extending from the front wall to the back wall, and
a right-side wall spaced apart from the left-side wall and extending from the bottom wall to the top wall and extending from the front wall to the back wall,
wherein the top wall and at least a portion of the front wall form a lid removable from a tray, perforation lines extend across the left-side wall from the top wall to the front wall to define a first opener strip, perforation lines extend across the right-side wall from the top wall to the front wall to define a second opener strip, and the first and second opener strips allow separation of portions of the lid from the tray to allow removal of the lid from the tray at the selection of a user.

2. The container of claim 1, wherein the front wall includes an upper portion and a lower portion separated by a cut line, and wherein the upper portion of the front wall is removable with the lid leaving the lower portion on the tray.

3. The container of claim 2, further comprising an interior panel coupled to the upper portion of the front wall for movement therewith and positioned in confronting relation with the lower portion of the front wall.

4. The container of claim 1, wherein perforation lines extend along upper edges of the left-side and right-side walls from the opener strips to the back wall to allow separation of the top wall from the left-side and right-side walls with removal of the lid from the tray.

5. The container of claim 4, wherein at least one perforation line extends along an upper edge of the back wall to allow separation of the top wall from the back wall with removal of the lid from the tray.

6. The container of claim 5, further comprising a break-away tab extending into the back wall and coupled to the top wall, wherein the break-away tab separates from the back wall with removal of the lid from the tray.

7. A one-piece blank used to form a container, the one-piece blank comprising
a plurality of first panels coupled to one another and adapted to define a tray when folded relative to one another, and
a plurality of second panels coupled together and adapted to define a lid mounted on the tray when the second panels are folded relative to one another,
wherein perforated tear lines extend across the plurality of first panels to allow removal of the lid from the tray at the selection of a user.

8. The one-piece blank of claim 7, wherein a front wall of the container is defined by one of the first panels forming a lower front-part and one of the second panels forming an upper front-part, and wherein another of the second panels is bonded to the upper front-part and position in confronting relation to the lower front-part.

9. The one-piece blank of claim 8, wherein a cut line separates the lower front-part from the upper front-part.

10. The one-piece blank of claim 7, wherein the plurality of first panels includes five first panels and the plurality of second panels includes two second panels.

11. The one-piece blank of claim 10, wherein the perforated tear lines extend along upper edges of at least three of the first panels.

12. The one-piece blank of claim 11, wherein the perforated tear lines further extend along opener strips positioned across at least three of the first panels.

13. The one-piece blank of claim 7, wherein a first of the plurality of first panels is bonded with a second of the plurality of first panels using an adhesive bond.

14. The one-piece blank of claim 13, wherein the first of the plurality of first panels is substantially equal in length to the second of the plurality of first panels.

15. The one-piece blank of claim 13, wherein the first of the plurality of first panels has an equal or lesser length relative to the second of the plurality of first panels.

16. A container comprising
a tray formed to include a product-storage space adapted to hold product for display of the product, and
a lid mounted on the tray to capture the product between the lid and the tray for shipping to a retail location,
wherein the lid and the tray are formed from a contiguous, one-piece blank of material having a plurality of panels folded relative to one another with portions bonded together along lines of perforation to couple the lid to the tray and allow separation of the lid from the tray at the selection of a user.

17. The container of claim 16, further comprising opener strips defined along portions of the lines of perforation between forward portions of the tray and the lid, wherein the opener strips allow a user to separate the forward portions of the lid and tray and lift the forward portion of the lid relative to the forward portion of the tray for removal of the lid from the tray.

18. The container of claim 17, wherein the opener strips extend across side walls of the container from a top wall of the container to a front wall of the container.

19. The container of claim 18, wherein the front wall includes an upper portion and a lower portion separated by a cut line, and wherein the upper portion of the front wall is removable with the lid leaving the lower portion on the tray.

20. The container of claim 19, further comprising an interior panel coupled to the upper portion of the front wall for movement therewith and positioned in confronting relation with the lower portion of the front wall.
